(19) United States
(12) Patent Application Publication
(10) Pub. No.: US 2019/0258619 A1
(43) Pub. Date: Aug. 22, 2019

(54) DATA COMPRESSION METHOD, DATA COMPRESSION DEVICE, COMPUTER PROGRAM, AND DATABASE SYSTEM

(71) Applicant: TURBO DATA LABORATORIES, INC., Kanagawa (JP)

(72) Inventor: Shinji Furusho, Kanagawa (JP)

(21) Appl. No.: 16/333,427

(22) PCT Filed: Aug. 10, 2017
(86) PCT No.: PCT/JP2017/029138

§ 371 Date: Mar. 14, 2019

(30) Foreign Application Priority Data
Sep. 14, 2016 (JP) 2016-179576

(51) Int. Cl. G06F 16/22; G06F 17/17; G06F 16/28

(52) U.S. Cl. CPC G06F 16/2272; G06F 16/284; G06F 17/17

(57) ABSTRACT

The object of the present disclosure is to compress array data with an improved compression efficiency so that an arbitrary portion in the array data may be promptly restored. Array data VL is divided into a plurality of blocks, and an approximate function is set in each of the blocks. For each entry included in each block k, a difference dV_i between a value V_i of the entry and a value F_k(i) obtained by substituting a rank i of the entry into an approximate function F_k set in a block k in which the entry is included is obtained. Then, a difference list dVL_k of the block k is created by arranging differences dV_i in the order of ranks of entries for which the differences dV_i are obtained. Then, a set of the approximate function F_k of each block k and the difference list dVL_k is set as block data BLD_k of the block k, and a set of the block data BLD_k obtained for each block is set as compressed data of the array data.

### TECHNICAL FIELD

The present disclosure relates mainly to a technique for compressing the data size of a database.

### BACKGROUND ART

As one of techniques for compressing the data size of a database, a technique is known that compresses a table of RDB (Relational Database) as illustrated in FIG. 6A into an index set which is a set of indexes of the table as illustrated in FIG. 6B (see, e.g., Patent Document 1).

Here, the table in FIG. 6A is a table with rows of records, each having a plurality of fields (“gender” and “times” in the figure). Each of the records is assigned with a record number representing the order (from 0 to 12) of records in the table. The record number starts from 0.

Further, the index set illustrated in FIG. 6B is constituted with indexes provided for each field of the records of the table of FIG. 6A. In FIG. 6A, since the fields of the records of the table are “gender” and “times”, the index of “gender” and the index of “times” are included in the index set.

Each index includes VNo and VL.

VL is a list having entries in which values used as values of the corresponding fields of the corresponding table are sorted by a predetermined criterion (e.g., the ascending order of values) and registered.

For example, for the index of “gender” in the index set of the table data set of the table illustrated in FIG. 6A, since only F and M are registered in the field of “gender” of the table, VL is a list formed with an entry in which F is registered and an entry in which M is registered.

Next, VNo is a list formed with the same number of entries as the number of records in the corresponding table. In the entry of rank n of VNo is registered a value indicating the ranking in the VL of the entry of VL in which a value of the corresponding field of the record of record number n of the corresponding table is registered. The ranking of VNo and VL starts from 0.

For example, for the index of “gender” in the index set of the table data set of the table illustrated in FIG. 6A, a value of the field of “gender” of the record of record number 2 of the table is M and the ranking of the entry of VL in which M is registered is 1. Therefore, 1 is registered in the entry of rank 2 of VNo.

According to such an index, the number of records in the corresponding table may be obtained promptly from the number of entries of VNo and a value of the corresponding field of a record of each record number may be promptly obtained from VNo and VL.

For example, rank 1 of VL is obtained from the entry of rank 2 of VNo corresponding to record number 2 of the index of “gender” and, since M is registered in the entry of rank 1 of VL, a value of the “gender” field of record number 2 is obtained as M.

Therefore, the table may be completely represented by the index set constituted with the indexes provided for each field of such a record and may be used promptly by using the index set.

In VL of an index corresponding to each field, a value used as the value of the field is registered only once regardless of how many times the value appears in the corresponding field in the table. Therefore, the index set serves as data obtained by compressing the table.

### RELATED LITERATURE

### Patent Documents

[Patent Document 1] JP-A-2000-339390

### DISCLOSURE OF THE INVENTION

### Problem that the Invention is to Solve

However, even when the table is compressed into the index set constituted with indexes provided for each field of the records as described above, as understood from a comparison between the index of the “gender” field in which values appearing in the field of FIG. 6B are only two, i.e., F and M and the index of the “times” field in which seven values from 6 to 110 appear, as the number of values used as values of the fields (the number of unique values) increases, the table may not be compressed with sufficient compression efficiency.

In the meantime, compression of the table into the index set needs to be performed so that a necessary portion of the table may be quickly acquired from the index set in order to use the table promptly.

Therefore, when array data such as VL may be compressed with an improved compression efficiency so that an arbitrary portion in the array data may be quickly restored, the table may be compressed with an improved compression efficiency so that it may be used promptly.

An object of the present disclosure is to compress array data with an improved compression efficiency so that an arbitrary portion in the array data may be promptly restored.

### Means for Solving the Problem

According to an aspect of the present disclosure, there is provided a method for compressing array data in which values are arranged, including: dividing the array data into a plurality of blocks; and creating block data for each of the blocks and including the created block data of each block in the compressed data. The creating block data includes setting a predetermined function representing a reference value of each value in the block as an approximate function in a block for creating the block data, obtaining a difference between each value included in the block and the reference value represented by the approximate function set in the block, and creating difference array data in which the obtained differences are arranged in the same order as the order within the block of the values for which the differences are obtained.

The creating block data may include setting a function representing an approximate value of each value in each block as a reference value of the value as the approximate function in each block.

The creating block data may include setting a function of minimizing the maximum value of a difference between each value of each block and the reference value of the value represented by the approximate function or the absolute value of the maximum value, as the approximate function, in each block.

The creating block data may include setting a function of representing the reference value of each value of the block as a variable which is the order of the value in the array data or the order of the value in the block, as the approximate function, in the block.

In the data compression method described above, the creating block data may include setting different kinds of functions for each block, as the approximate function, in each block.

The dividing the array data may include: dividing a first block from the array data by adding a value of the array data included in the first block from the head value of the array data until a compression rate of the block data of the block is deteriorated by a predetermined level or more; and dividing second and subsequent blocks from the array data by adding a value of the array data included in the second and subsequent blocks from a value next to the last value included in a block preceding by one on the array data until a compression rate of the block data of the block is deteriorated by a predetermined level or more.

According to the data compression method, the array data is divided into a plurality of blocks and an approximate function is set for each block. Therefore, it is possible to set a block for each range of values with common tendency and to set an appropriate approximate function corresponding to the tendency of the values in the block for each block. Then, when an appropriate approximate function corresponding to the tendency of values in the block may be set for each block, a range of differences registered in the differential array data of each block data may be made smaller than a range of values registered in the array data. As a result, it is possible to reduce the number of bits of data representing the differences in the difference array data and to generate compressed data as data obtained by compressing the array data with high compression efficiency.

In addition, according to the data compression method of the present disclosure, it is possible to restore a necessary portion of the array data using only block data of a block including the necessary portion. In addition, even when values are not arranged in the ascending or descending order and the array data may not be sufficiently effectively compressed by differential compression in which the values are encoded into values preceding by one on the array data, it may be expected that effective compression may be achieved. Even when the array data may not be sufficiently compressed by differential compression in which the values are encoded into values preceding by one on the array, according to the present disclosure, it may be expected that effective compression may be achieved. In addition, when the values are variable-length coded, in order to restore a specific value of the array data, a data portion indicating the specific value in the variable-length coded data has to be accessed after performing a special process of estimating a position of the data portion. However, according to the compression data of the present disclosure, even when the bit lengths of each block data are made equal to each other, the effect of compression may be expected. Further, by equalizing the bit lengths of each block data, it is possible to easily estimate a data position of a difference representing each value in the block data and access the difference.

According to yet another aspect of the present disclosure, there is provided a data compressing device for performing the above-described data compressing method and a computer program that causes a computer to execute the above-described data compressing method.

According to yet another aspect of the present disclosure, there is provided a database system including a data compressing device for performing the above-described data compressing method and a database containing the compressed data. The database system includes: a database operation unit configured to calculate a value of a predetermined portion of the array data by adding a difference corresponding to the portion of the differential array data of the block data to a reference value of the portion indicated by the approximate function of the block data of the block of the compressed data including the value of the portion.

### Advantage of the Invention

As described above, according to the present disclosure, it is possible to compress array data with an improved compression efficiency so that an arbitrary portion in the array data may be promptly restored.

### BRIEF DESCRIPTION OF THE DRAWINGS

FIG. 1 is a view illustrating the outline of a compression procedure according to an embodiment of the present disclosure;

FIG. 2 is a view illustrating an example of an approximate function according to an embodiment of the present disclosure;

FIG. 3 is a block diagram illustrating the configuration of a data processing system according to an embodiment of the present disclosure;

FIG. 4 is a flowchart illustrating a compression process according to an embodiment of the present disclosure;

FIG. 5 is a view illustrating an example of compression of a table according to an embodiment of the present disclosure; and

FIG. 6 is a view illustrating an example of compression of a table in the related art.

### MODE FOR CARRYING OUT THE INVENTION

Hereinafter, embodiments of the present disclosure will be described.

First, the outline of an array data compression procedure according to an embodiment of the present disclosure will be described.

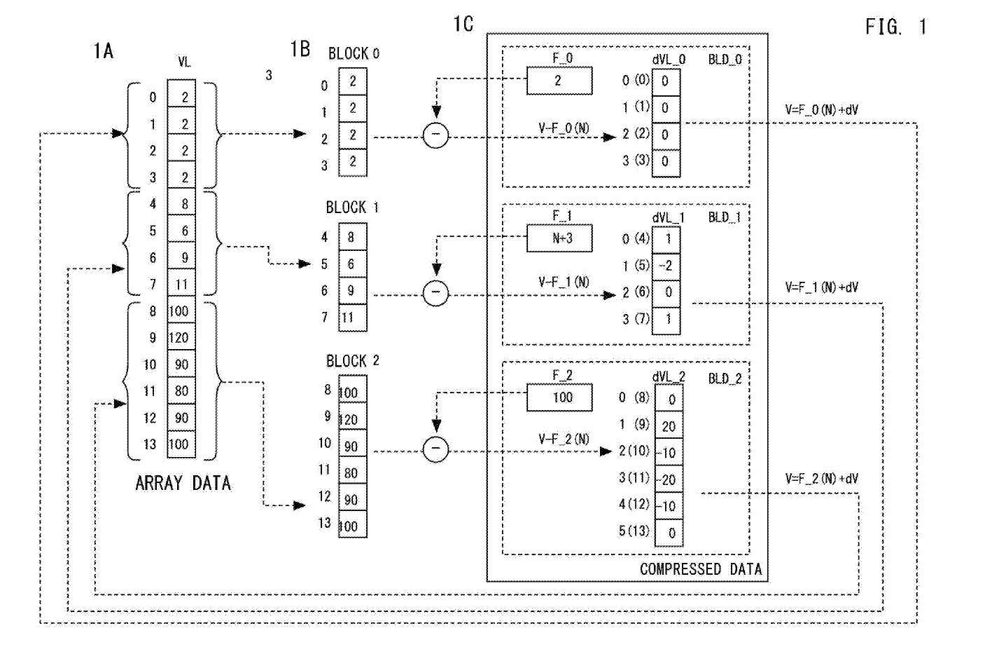

FIG. 1A illustrates array data VL to be compressed. As illustrated, the array data VL is a one-dimensional array of a plurality of entries with values V registered therein. In the array data VL, the values V are registered in their respective entries of the array data VL. In addition, each entry is given a rank N indicating the order in the array data VL.

In the array data compression procedure according to the present embodiment, as illustrated in FIG. 1B, the array data VL is divided into a plurality of blocks, which will be described in detail later.

Then, an approximate function is set for each of the blocks. Here, it is assumed that the k-th block is represented as a block k and an approximate function set for the block k is represented by F_k. This approximate function will also be described in detail later.

Then, the following process is performed for each block.

As illustrated in FIG. 1C, for each entry included in the block k, a difference (dV_i) between a value V_i of an entry i and a value F_k(i) obtained by substituting a rank i in the array data VL of the entry i in the approximate function F_k set for the block k including the entry i is obtained as follows: dV_i=V_i−F_k(i). Here, the entry i represents an entry of rank i of the array data VL, V_i represents a value v registered in the entry i, and dV_i represents a difference dV obtained for the entry i.

Then, a list in which differences dV_i are arranged in the order of ranks of entries of the block k for which the differences dV_i are obtained is generated as a difference list dVL_k of the block k.

Then, a set of the approximate function F_k and the difference list dVL_k obtained for each block k as described above is set as block data BLD_k of the block k, and a set of block data obtained for each block is set as compression data of the array data of FIG. 1A. However, the difference list dVL_k of each block k is generated such that the number of bits of data of each difference dV of the difference list dVL_k of each block k is the minimum number of bits sufficient to express a value within a distribution range of the differences dV registered in the difference list dVL_k.

More specifically, referring to FIG. 1, the array data VL to be compressed illustrated in FIG. 1A is formed with 14 entries having ranks from 0 to 13 and the value V is registered in the ascending order in each entry.

In the following description, for the sake of convenience, the rank in the array data VL of the entries of the array data VL is expressed as an “entry rank”.

Next, as illustrated in FIG. 1B, the array data VL of FIG. 1A is divided into three blocks, i.e., a block 0 including entries of entry ranks 0 to 3, a block 1 including entries of entry ranks 4 to 7, and a block 2 including entries of entry ranks 8 to 13.

Then, as illustrated in FIG. 1C, a constant function F_0(N)=2 is set as an approximate function F_0 for the block 0, a linear function F_1(N)=N+3 is set as an approximate function F_1 for the block 1, and a constant function F_2(N)=100 is set as an approximate function F_2 for the block 2. Where, N represents an entry rank.

Then, for the block 0, differences between values V_1 to V_3 of entries of the entry ranks 0 to 3 of the array data VL included in the block 0 and a value (a constant 2 in this example) obtained by substituting the entry ranks into the approximate function F_0(N)=2 are calculated as differences dV_0 to dV_3 of the entry ranks 0 to 3. That is, for example, since the value V_2 of the entry with the entry rank 2 is 2 and F_0(2) is 2, a difference 0 between 2 and 2 is calculated as a difference dV_2 of the entry rank 2. Then, an array in which the differences dV_0 to dV_3 obtained for the entries of the entry ranks 0 to 3 are registered in the order conforming to the entry rank of the entry for which the difference dV is obtained is a difference list dVL_0 of the block 0. In this example, as illustrated, since a distribution range of differences dV registered in the difference list dVL_0 is a range including only 0 which may be expressed by only 1 bit, the difference list dVL_0 is an array in which data of bit number 1 is stored as each difference dV.

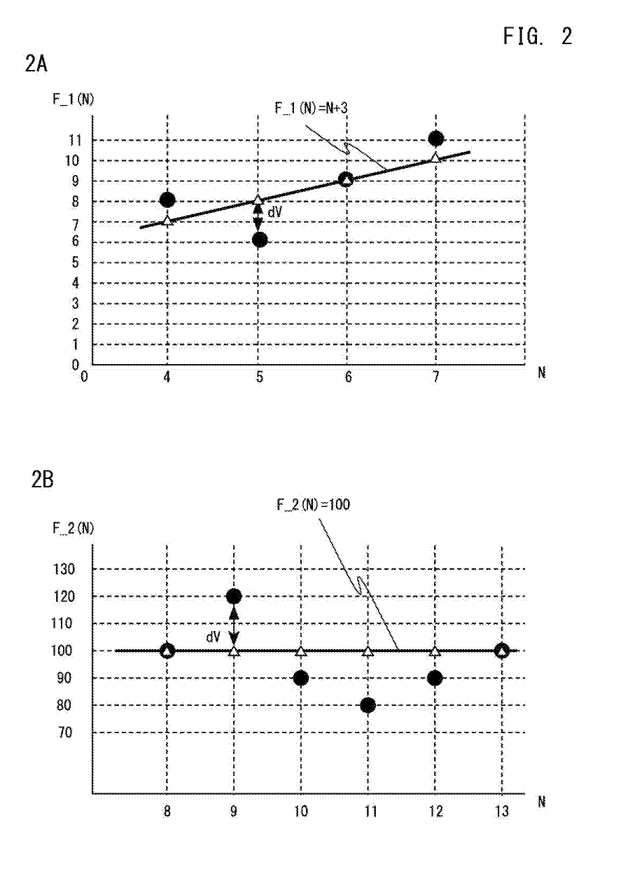

Similarly, for the block 1, differences dV between values V_4 to V_7 of each of entries of the entry ranks 4 to 7 included in the block 1 and a value F_1(N)=N+3 (indicated by a triangle in FIG. 2A) obtained by substituting the entry ranks into the approximate function F_1=N+3 are calculated as differences dV_4 to dV_7 of each of the entry ranks 4 to 7. That is, for example, since the value V_5 of the entry with the entry rank 5 is 6 and F_1(5) is 5+3=8, a difference −2 between 6 and 8 is calculated as a difference dV_5 of the entry of the entry rank 5. Then, an array of entry rank orders of the differences dV_4 to dV_7 obtained for the entry ranks 4 to 7 is a difference list dVL_1 of the block 1. In this example, as illustrated, since a distribution range of differences dV registered in the difference list dVL_1 is a range from −2 to 1 which may be expressed by 3 bits with one bit assigned respectively to positive and negative signs, the difference list dVL_1 is an array in which data of bit number 3 is stored as each difference dV.

Similarly, for the block 2, differences dV between values V_8 to V_13 of each of entries of the entry ranks 8 to 13 included in the block 2 and a value (indicated by a triangle in FIG. 2B) (a constant 100 in this example) obtained by substituting the entry ranks into the approximate function F_2(N)=100 are calculated as differences dV_8 to dV_13 of the entry ranks 8 to 13. That is, for example, since the value V_9 of the entry with the entry rank 9 is 120 and F_2(9) is 100, a difference 20 between 120 and 100 is calculated as a difference dV_9 of the entry rank 9. Then, an array of entry rank orders of the differences dV_8 to dV_13 obtained for the entry ranks 8 to 13 is a difference list dVL_2 of the block 2. In this example, as illustrated, since a distribution range of differences dV registered in the difference list dVL_2 is a range from −20 to 20 which may be expressed by 6 bits with one bit assigned respectively to positive and negative signs, the difference list dVL_2 is an array in which data of bit number 6 is stored as each difference dV.

Then, the approximate function F_0 set for the block 0 and the difference list dVL_0 obtained for the block 0 are block data BLD_0 of the block 0, the approximate function F_1 set for the block 1 and the difference list dVL_1 obtained for the block 1 are block data BLD_1 of the block 1, and the approximate function F_2 set for the block 2 and the difference list dVL_2 obtained for the block 2 are block data BLD_2 of the block 2. c_1, the block data BLD_2, and the block data BLD_3 are compression data.

In this case, the compression data may include block management data for managing each block, in addition to the block data BLD of each block. In addition, in this case, the block management data may include entry ranks of the array data VL included in each block, data indicating identification of the block data BLD of each block, and the like.

The outline of the array data compression procedure according to the present embodiment has been described above.

The value V of the entry of each entry rank of the array data VL may be obtained from the compression data illustrated in FIG. 1C, as follows. That is, for an entry of an entry rank i of the array data VL, a block k to which the entry rank i belongs is obtained and an approximate function F_k is acquired from the block data BLD_k of the block k. Further, assuming that a value obtained by subtracting the entry rank of the head entry of the block k from i is j, a difference dV_i obtained for the entry of the entry rank i is acquired from the j-th entry of the difference list dVL_k of the block data BLD_k of the block k. Then, a value obtained by V_i=F_k(i)+dV_i is set as a value V_i of the entry of the entry rank i of the array data VL.

The numerals in parentheses in the left of each entry of the difference list dVL_n in the figure indicate the entry rank in the array data VL of the entry of a block from which the difference dV of the entry is obtained.

Specifically, for example, for an entry of entry rank 5 of the array data VL, the entry of the entry rank 5 belongs to the block 1 and an approximate function registered in the block data BLD_1 is F_1(N)=N+3. Since the entry rank of the head entry of the block 1 is 4, a value obtained by subtracting 4 from the entry rank 5 is 1. Then, a difference registered in the entry of rank 1 of the difference list dVL_1 of the block data BLD_1 is −2, and a value 6 of the entry of the entry rank 5 of the array data VL is obtained according to V_5=F_1(5)+(−2)=8−2=6.

In this way, with the compression data according to the present embodiment, simply by referring to the block data BLD_k of a block to which the entry of the entry rank belongs, a value of the entry of a desired entry rank of the array data VL may be promptly obtained without a process such as decompressing the entire compression data.

Next, when a range of differences dV registered in each difference list dVL_k is a range that may be represented by data of a bit number smaller than a bit number of data representing the value V of each entry of the array data VL, the compression data may be data of a smaller amount than the array data, that is, data obtained by compressing the array data VL.

The distribution of differences dV is determined by a distribution of values V of each entry in each block and an approximate function set for the block. In addition, since the array of the array data VL is close to the value V and hence the value V in each block is often highly correlated with some tendency, it may be expected that there is an approximate function that may be suppressed such that the distribution of differences dV becomes small in conformity with such tendency.

In addition, each difference list dVL_k is provided as independent array data, and the number of bits of data of the differences dV of the difference list dVL_k of each block may be set independently of the differences dV of the other blocks.

Accordingly, by appropriately setting each block and an approximate function of the block, it is possible to generate compression data as data obtained by compressing the array data with high compression efficiency.

Therefore, in the present embodiment, compression data is generated by setting a block and an approximate functions so as to obtain an improved compression efficiency, as described below.

Now, a more detailed configuration for generating compression data from array data will be described.

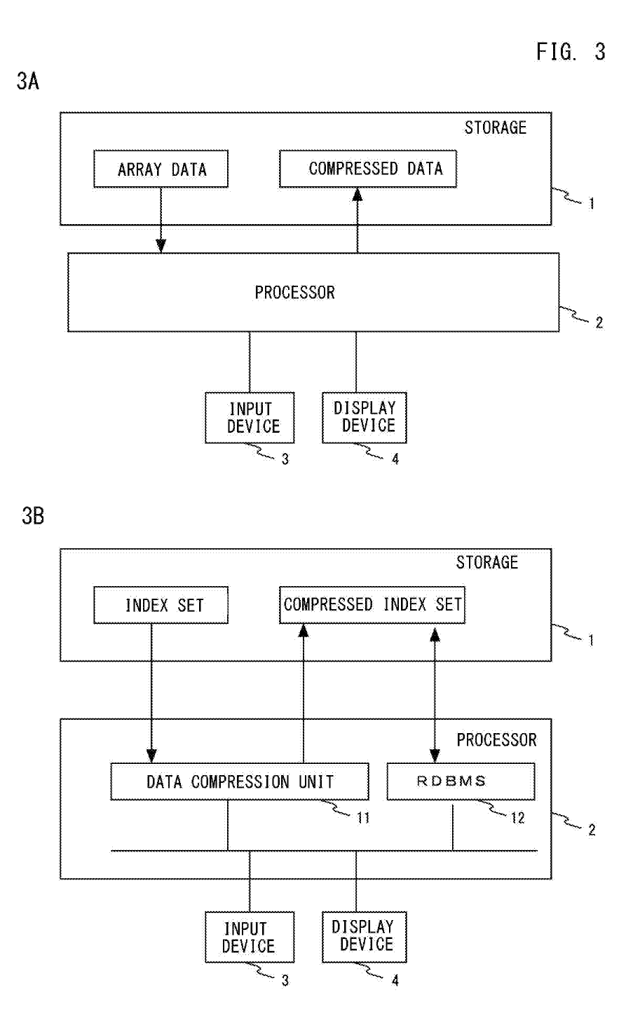

First, generation of compression data from array data may be performed, for example, in a data processing system illustrated in FIG. 3A.

The data processing system illustrated in FIG. 3A includes a storage 1, a processor 2, an input device 3, a display device 4, and the like.

The storage 1 stores array data to be compressed. The processor 2 reads the array data from the storage 1, creates compression data, and stores it in the storage 1.

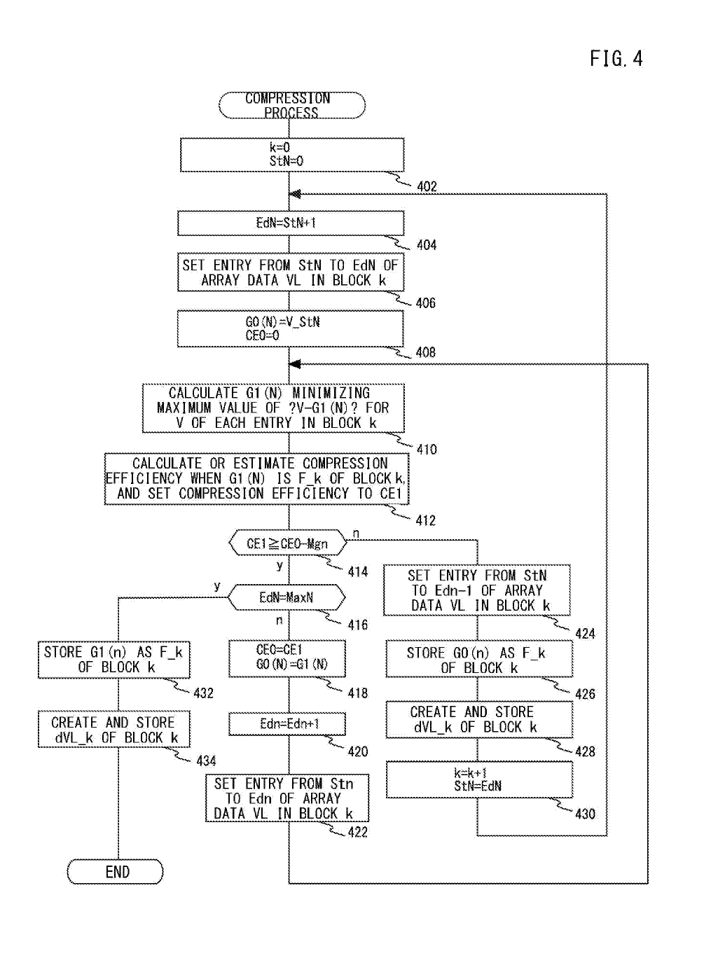

The processor 2 performs a compression process illustrated in FIG. 4 in order to generate the compression data from the array data. The compression process used herein is a process implemented by the processor 2 executing a predetermined computer program.

As illustrated in FIG. 4, in the compression process, first, k is set to 0 and StN is set to 0 (Step 402).

Next, EdN is set to StN+1 (Step 404) and an entry of an entry rank of the array data from StN to EdN is set in a block k (Step 406). Here, the block k represents the k-th block.

Then, a function GO(N) is set to a constant function G0(N)=V_StN and CEO is set to 0 (Step 408). Here, V_StN is a value V of an entry whose entry rank of the array data VL is StN.

Next, a function G1(N) that minimizes the maximum value of the absolute value of a difference V-G1(N) obtained for the value V of the entry of each entry rank of the block k is calculated (Step 410). Here, in Step 410, for example, a line connecting values V of the block k in the order of entry ranks is approximated in each of a constant function, a linear function, a quadratic function, a trigonometric function, and other arbitrary functions previously defined as the type of function to be used as an approximate function, and a function that may be best approximated is calculated as the approximate function G1(N). However, the approximate function G1(N) is calculated on the presumption that G1(N) having a smaller maximum value of the absolute value of V-G1(N) is a function better approximating the line connecting the values V of the block k in the order of entry ranks. Further, the approximate function G1(N) may be calculated such that the difference V-G1(N) obtained for the value V of each entry of the block k is necessarily positive. By doing so, since the difference dV is necessarily positive, it is possible to commonly use positive and negative sign-less data as data representing the difference dV.

Then, using the calculated function G1(N) as an approximate function F_k of the block k, the compression efficiency in the case where the block k is compressed to the above-described block data BLD_k is calculated or estimated and set to CE1 (Step 412). Here, for example, when the block data BLD_k of the block k is generated by actually using the function G1(N) as the approximate function F_k of the block k, the data amount of the block data BLD_k is estimated and the compression efficiency is calculated according to the following expression and is set to CE1.

Compression efficiency=(data amount of block k of array data VL−data amount of block data BLD_k)/(data amount of block k of array data VL)

Here, the compression efficiency indicates how much the data amount is compressed by replacing the block k of the array data VL with the block data BLD_k. The higher compression efficiency indicates that the data amount is more compressed, i.e., that the block data BLD_k more compresses the block k of the array data VL. The compression efficiency of 0 indicates that the data amount of the block data BLD_k is equal to the data amount of the block k of the array data VL, i.e., that the data amount is not compressed at all.

Next, it is checked whether or not CE1 calculated in Step 412 is equal to or larger than a value obtained by subtracting a predetermined margin MGN from CEO (Step 414). Here, the margin MGN is a parameter for adjusting easiness of division of the array data VL into blocks. An appropriate value may be set in the margin MGN depending on a compression policy of the array data VL. Further, the margin MGN may be zero.

When it is determined that CE1 is equal to or larger than the value obtained by subtracting the predetermined margin MGN from CEO (“Yes” in Step 414), it is checked whether or not EdN is equal to the last entry rank MaxN of the array data VL (Step 416).

When it is determined that EdN is not equal to MaxN (“No” in Step 416), the current CE1 is set as the later CEO and the current G1(N) is set as the later G0(N) (Step 418).

Then, EdN is incremented by 1 (Step 420), an entry whose entry rank of the array data VL is from StN to EdN is set in the block k (Step 422), and the process returns to Step 410.

In the meantime, when it is determined that CE1 is not equal to or larger than the value obtained by subtracting the predetermined margin MGN from CEO (“No” in Step 414), an entry whose entry rank of the array data VL is from StN to EdN−1 is set in the block k (Step 424), and the current GO(N) is stored as the approximate function F_k of the block k (Step 426). Further, using the stored approximate function F_k, a difference list dVL_k of the block k is created and stored as described above (Step 428).

Then, k is incremented by 1 and the current EdN is set to new StN (Step 430), and the process returns to Step 404.

In the meantime, when it is determined that EdN is equal to MaxN (“Yes” in Step 416), the current G1(N) is stored as the approximate function F_k of the block k (Step 432). Further, using the stored approximate function F_k, the difference list dVL_k of the block k is created and stored as described above (Step 434).

Then, the compression process is terminated.

The compression process performed by the processor has been described above.

When the above-described block management data is included in the compression data, a process of creating and storing the block management data during or after the compression process of FIG. 4 is added.

According to such a compression process, an entry of the array data VL included in a temporary block is incremented one by one from an entry next to the tail entry of the last set block and the compression efficiency is estimated when the temporary block is compressed. Thus, when the compression efficiency has not been deteriorated by more than a predetermined level than before the last entry is incremented, when the compression efficiency has not been deteriorated than before the last entry is increased, or when the compression efficiency has not been improved by a predetermined level or more than before the last entry is incremented, the array data VL is divided into a plurality of blocks by repeating a process of setting the temporary block before increasing the last entry as a block.

According to the compression process, the approximate function for each block may be set so that the maximum value of the absolute value of the difference dVL registered in the difference list dVL of the block is as small as possible. When the maximum value of the absolute value of the difference dVL registered in the difference list dVL is small, data having a small number of bits may be used as data representing the difference dVL, so that the data amount of the difference list dVL may be reduced to be as small as possible.

Therefore, according to the compression process, it is possible to set a block and a corresponding approximate function so as to obtain an improved compression efficiency, which can result in compression of the array data VL into compression data with high compression efficiency.

Further, according to the compression data generated by such a compression process, it is possible to restore the necessary portion of the array data using only block data of a block including the necessary portion. In addition, according to such a compression process, even when values are not arranged in the ascending or descending order and the array data may not be sufficiently effectively compressed by differential compression in which the values are encoded into values preceding by one on the array data, it may be expected that effective compression may be achieved. In addition, when the values are variable-length coded, in order to restore a specific value of the array data, a data portion indicating the specific value in the variable-length coded data has to be accessed after performing a special process of estimating a position of the data portion. However, according to the compression data generated by the above-described compression process, even when the bit lengths of each block data are made equal to each other, the effect of compression may be expected. Further, by equalizing the bit lengths of each block data, it is possible to easily estimate a data position of a difference representing each value in the block data and access the difference.

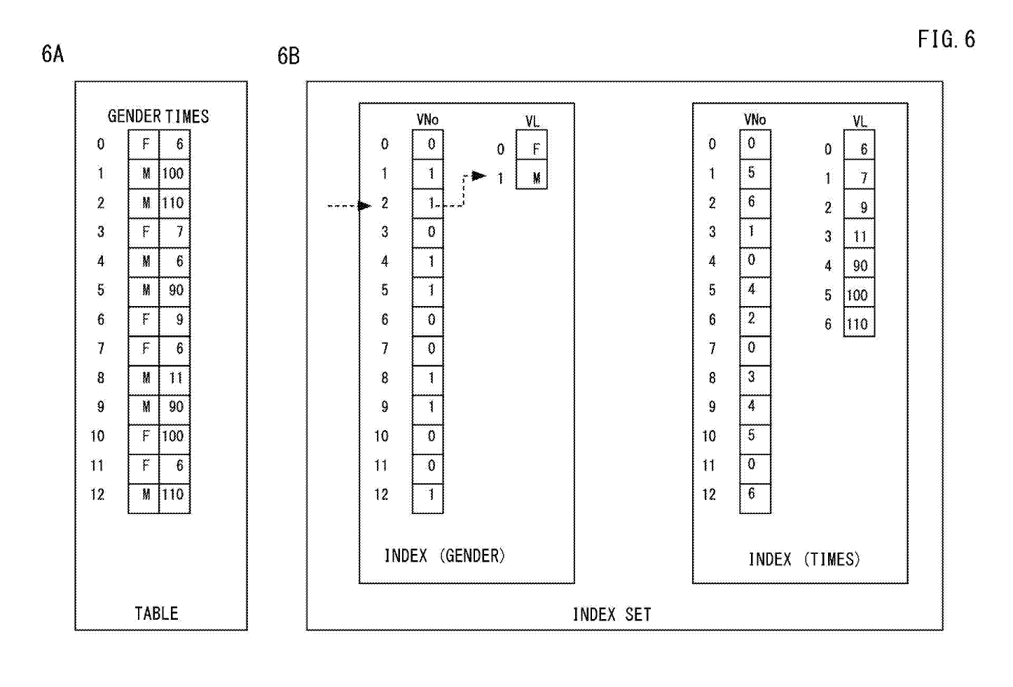

The above-described technique of compressing the array data VL may be first applied to compression of an index set illustrated in FIG. 6.

That is, in this case, as illustrated in FIG. 3B, the processor 2 includes a data compression unit 11 and an RDB management system (RDBMS) 12. The data compression unit 11 and the RDBMS 12 are functional units implemented by the processor 2 executing a predetermined computer program.

Then, the data compression unit 11 creates a compressed index set obtained by compressing the index set stored in the storage 1, stores it in the storage 1, and erases the index set. In addition, the RDBMS 12 uses the compressed index set to operate a table represented by the compressed index set (a table already represented by the index set).

Here, the compressed index set obtained by compressing the index set in the data compression unit 11 is created as follows.

That is, with VL of each index in the index set as the array data VL to be compressed, the compressed data compressed by the above-described compression process is generated as compressed VL. Then, data obtained by replacing VL of each index of the index set with the compressed VL obtained by compressing the VL is generated as a compressed index set.

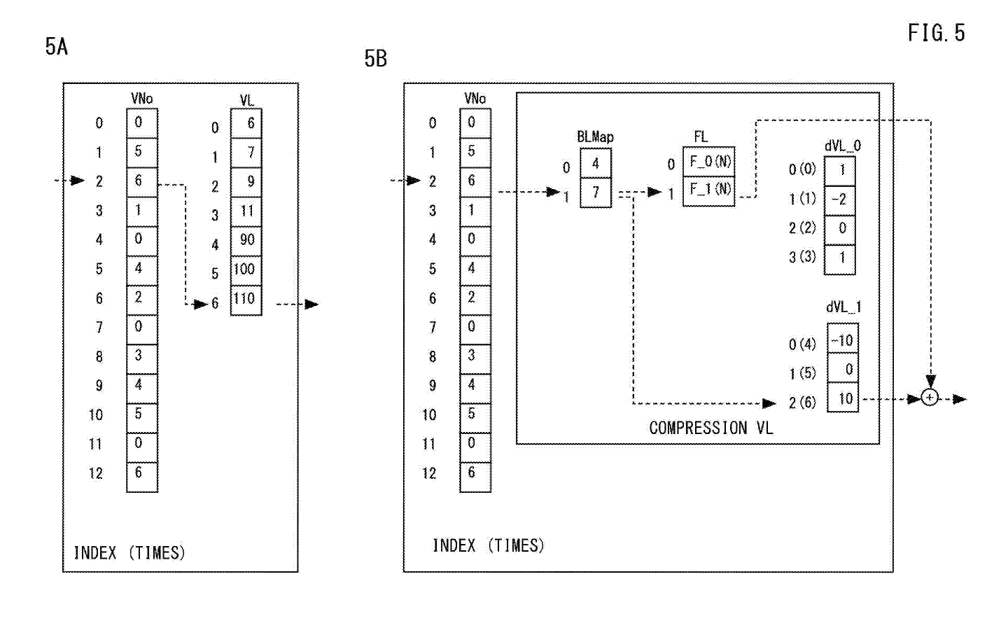

An example of the compressed VL created by compressing VL of each index is illustrated in FIG. 5.

FIG. 5B illustrates an index of the “times” field in the compressed index set generated by replacing VL of the “times” field in an index set illustrated in FIG. 5A with compressed VL.

As illustrated, the compressed VL includes a difference list dVL_n for each block, an approximate function list FL in which approximate functions F_n are stored in the order of blocks, and a BL_MAP. The BL_MAP corresponds to the above-described block management data, and stores the head entry rank of the next block of each block in the order of blocks. However, a number obtained by adding 1 to the maximum entry rank of VL is registered in the last entry of BL_MAP.

Here, since VL of the index is sorted and registered according to a predetermined criterion, the value V in each block has a certain tendency in accordance with the above criterion. Further, in many cases, it is possible to set an approximate function that may suppress the distribution of differences dV for each block to be as small as possible effectively. Therefore, according to the present embodiment, it may be expected that VL of the index may be compressed with high compression efficiency.

When operating the table represented by the compressed index set, the RDBMS 12 obtains a value of each field of each record as follows.

That is, in a case of obtaining the value of a field X of a record number A which corresponds to the index illustrated in FIG. 5B, an entry rank B of VL storing the value of the field X of the record number A is obtained by referring to VNo of the index of the field X. Next, by referring to the BL_MAP, an order k of a block to which an entry of the entry rank B of VL belongs and an entry rank j of the difference list dVL_1 in which a difference dV obtained from the entry of the entry rank B within the block k is stored are obtained. Then, the approximate function F_k of the block k is acquired from the approximate function list FL and a difference dV_B of the entry of the entry rank B of VL is acquired from the entry of the rank j of the difference list dVL_k of the block k. Then, the value V of the field X of the record of the record number A is calculated by F_k(B)+dV_B from the approximate function F_k and the difference dV_B.

More specifically, for example, in a case of obtaining the value of the “times” field of a record number 2 which corresponds to the index illustrated in FIG. 5B, an entry rank 6 of VL storing the value of the “times” field of the record number 2 is obtained by referring to VNo. Next, since an entry rank 4 of the head entry of the second block is registered in the entry of rank 0 of the BL_MAP and the next entry rank 7 of the tail entry of the second block is registered in the entry of rank 1 of the BL_MAP, a block to which the entry of an entry rank 6 of VL belongs is obtained as a second block 1. In addition, since the entry rank of the head entry of the second block 1 is 4, a difference dV obtained from the entry of the entry rank 6 of VL is stored in the entry of rank 2 of the difference list dVL_1 of the block 1.

Therefore, an approximate function F_1=100 of the block 1 stored in the entry of rank 1 of the approximate function FL is acquired. Further, a difference 10 stored in the entry of rank 2 of the difference list dVL_1 of the block 1 is acquired.

Then, a value V of the “times” field of the record of the record number 2 is calculated by V=100+10=110 from the acquired approximate function F_1=100 and difference 10.

The compression of the index set illustrated in FIG. 6 has been described above.

In addition, the case of compressing VL of an index into the compressed VL has been described above. However, VNo of the index may be compressed into compressed VNo in the same manner.

Here, although values of VNo of the index are not sorted according to a predetermined criterion, unlike VL, even in a case where the array data may not be sufficiently compressed by the differential compression that encodes the values to values preceding by one on the array data, it may be expected that effective compression may be achieved as compared with the differential compression.

The embodiment of the present disclosure has been described above.

In the above embodiment, the case where the array data VL compressed into the compressed data is stored as numerical values V has been described. However, the present embodiment may be equally applied to a case where the array data VL is stored as a character string of the values V. That is, in this case, a character code string representing the character string may be regarded as numerical values or converted into numerical values and then, the same process as described above may be performed for the character code string.

Further, in the above embodiment, data obtained by compressing and encoding the difference dV according to an appropriate compression/encoding rule may be stored in the difference list dVL.

Further, in the above embodiment, an example has been described in which a function F_k(N) having a rank N in the array data VL of the entry of a block as a variable is set as an approximate function F for each block k. However, a function F_k(n) having a rank n in a block of a block entry as a variable may be set as an approximate function for each block.

Further, in the above embodiment, the difference lists dVL of each block are provided as mutually-independent array data. However, in a case where it is not necessary to make the number of bits different for each difference list dVL, the difference lists dVL of each block may be collectively provided as one array data.

### DESCRIPTION OF REFERENCE NUMERALS AND SIGNS

1: storage
2: processor
3: input device
4: display device
11: data compression unit
12: RDBMS

What is claimed is:

1. A method for compressing array data in which values are arranged, comprising:
dividing the array data into a plurality of blocks; and
creating block data for each of the blocks and including the created block data of each block in the compressed data,
wherein the creating block data includes setting a predetermined function representing a reference value of each value in the block as an approximate function in a block for creating the block data, obtaining a difference between each value included in the block and the reference value represented by the approximate function set in the block, creating difference array data in which the obtained differences are arranged in the same order as the order within the block of the values for which the differences are obtained, and creating the set approximate function and the created difference array data as block data of the block.

2. The method according to claim 1, wherein the creating block data includes setting a function representing an approximate value of each value in each block as a reference value of the value as the approximate function in each block.

3. The method according to claim 1, wherein the creating block data includes setting a function of minimizing the maximum value of a difference between each value of each block and the reference value of the value represented by the approximate function or the absolute value of the maximum value, as the approximate function, in each block.

4. The method according to claim 1, wherein the creating block data includes setting a function of representing the reference value of each value of the block as a variable which is the order of the value in the array data or the order of the value in the block, as the approximate function, in the block.

5. The method according to claim 1, wherein the creating block data includes setting different kinds of functions for each block, as the approximate function, in each block.

6. The method according to claim 1, wherein the dividing the array data includes:
dividing a first block from the array data by adding a value of the array data included in the first block from the head value of the array data until a compression rate of the block data of the block is deteriorated by a predetermined level or more; and
dividing second and subsequent blocks from the array data by adding a value of the array data included in the second and subsequent blocks from a value next to the last value included in a block preceding by one on the array data until a compression rate of the block data of the block is deteriorated by a predetermined level or more.

7. A device for compressing array data in which values are arranged, comprising:
a division unit configured to divide the array data into a plurality of blocks; and
a block data creation unit configured to create block data for each of the blocks and include the created block data of each block in the compressed data,
wherein the block data creation unit sets a predetermined function representing a reference value of each value in the block as an approximate function in a block for creating the block data, obtains a difference between each value included in the block and the reference value represented by the approximate function set in the block, creates difference array data in which the obtained differences are arranged in the same order as the order within the block of the values for which the differences are obtained, and creates the set approximate function and the created difference array data as block data of the block.

8. The device according to claim 7, wherein the block data creation unit sets a function representing an approximate value of each value in each block as a reference value of the value as the approximate function in each block.

9. The device according to claim 7, wherein the block data creation unit sets a function of minimizing the maximum value of a difference between each value of each block and the reference value of the value represented by the approximate function or the absolute value of the maximum value, as the approximate function, in each block.

10. The device according to claim 7, wherein the block data creation unit sets a function of representing the reference value of each value of the block as a variable which is the order of the value in the array data or the order of the value in the block, as the approximate function set in the block.

11. The device according to claim 7, wherein the block data creation unit sets different kinds of functions for each block, as the approximate function, in each block.

12. The device according to claim 7, wherein the division unit divides a first block from the array data by adding a value of the array data included in the first block from the head value of the array data until a compression rate of the block data of the block is deteriorated by a predetermined level or more, and divides second and subsequent blocks from the array data by adding a value of the array data included in the second and subsequent blocks from a value next to the last value included in a block preceding by one on the array data until a compression rate of the block data of the block is deteriorated by a predetermined level or more.

13. (canceled)

14. A database system including a device for compressing data according to claim 7 and a database containing the compressed data, comprising:
a database operation unit configured to calculate a value of a predetermined portion of the array data by adding a difference corresponding to the portion of the differential array data of the block data to a reference value of the portion indicated by the approximate function of the block data of the block of the compressed data including the value of the portion.

15. The method according to claim 2, wherein the creating block data includes setting a function of minimizing the maximum value of a difference between each value of each block and the reference value of the value represented by the approximate function or the absolute value of the maximum value, as the approximate function, in each block.

16. The method according to claim 2, wherein the creating block data includes setting a function of representing the reference value of each value of the block as a variable which is the order of the value in the array data or the order of the value in the block, as the approximate function, in the block.

17. The method according to claim 2, wherein the creating block data includes setting different kinds of functions for each block, as the approximate function, in each block.

18. The method according to claim 2, wherein the dividing the array data includes:
dividing a first block from the array data by adding a value of the array data included in the first block from the head value of the array data until a compression rate of the block data of the block is deteriorated by a predetermined level or more; and
dividing second and subsequent blocks from the array data by adding a value of the array data included in the second and subsequent blocks from a value next to the last value included in a block preceding by one on the array data until a compression rate of the block data of the block is deteriorated by a predetermined level or more.

19. The method according to claim 3, wherein the creating block data includes setting a function of representing the reference value of each value of the block as a variable which is the order of the value in the array data or the order of the value in the block, as the approximate function, in the block.

20. The method according to claim 3, wherein the creating block data includes setting different kinds of functions for each block, as the approximate function, in each block.

21. The method according to claim 3, wherein the dividing the array data includes:
dividing a first block from the array data by adding a value of the array data included in the first block from the head value of the array data until a compression rate of the block data of the block is deteriorated by a predetermined level or more; and
dividing second and subsequent blocks from the array data by adding a value of the array data included in the second and subsequent blocks from a value next to the last value included in a block preceding by one on the array data until a compression rate of the block data of the block is deteriorated by a predetermined level or more.
